(19) United States
(12) Patent Application Publication
(10) Pub. No.: US 2005/0164901 A1
(43) Pub. Date: Jul. 28, 2005

(54) Dishwashing wipe

(75) Inventors: Peter Robert Foley, Cincinnati, OH (US); Francis Cornelio Ford, Cincinnati, OH (US); Jerry Keith McGinnis, West Chester, OH (US); David Patrick Kreuzer, Fairfield, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/043,545

(22) Filed: Jan. 26, 2005

Related U.S. Application Data
(60) Provisional application No. 60/539,295, filed on Jan. 26, 2004.

(51) Int. Cl. C11D 17/00

(52) U.S. Cl. 510/438

(57) ABSTRACT

According to the present invention there is provided a wipe comprising a water-insoluble substrate and a cleaning composition, said cleaning composition comprising from 1% to 15% water, a sulphate-containing surfactant and a buffer.

### CROSS REFERENCE TO RELATED APPLICATION

This application claims priority to U.S. Provisional Application Ser. No. 60/539,295, filed Jan. 26, 2004, the disclosure of which is incorporated by reference.

### TECHNICAL FIELD

The present invention relates to a cleaning wipe comprising a cleaning composition. The cleaning composition is specifically formulated such that, on addition of water to the wipe, the cleaning composition is released slowly.

### BACKGROUND TO THE INVENTION

Dish care products, particularly hand dishwashing products, have traditionally been marketed in a variety of forms such as scouring powders, pastes, aqueous liquids and gels. Recently the focus has been on the development of dishcare products in the form of a wipe. More specifically a disposable wipe comprising already incorporated cleaning composition. One problem with such executions however is the rate of dispensing of the cleaning composition from the wipe. Whether the wipe is wet or dry, the cleaning composition, which must be water-soluble in order to be effective on the dishware, leaks into the wash water and solubilises. The wash water thus contains the cleaning composition and the wipe is used as the dishcloth. As with regular dishwashing products dispensed from bottles, the initial suds generated on addition of the cleaning composition to the wash water, die or dissipate over time. This is a negative signal to the consumer, who generally believes that when here are no more suds, there is no more efficacy. It has therefore been an objective of the dishwashing detergent manufacturer to develop dishwashing detergents that maintain suds for an extended period.

The dishwashing wipe form provides a new method of delivering extended mileage of suds volume. Theoretically if the release of cleaning composition into the dishwashing water can be delayed such that new detergent is released into the dishwashing water throughout the washing process, then suds can also be generated throughout the washing process. Methods for delaying the release of detergent from a cleaning wipe have been discussed in the prior art. Such methods include manufacturing the wipe substrate such that the cleaning detergent is housed in a separate area, or between water-impermeable films or in friable or rupturable capsules. However the Applicant has found that these options all present problems. Water impermeable films release surfactant too slowly to give consumer appreciable sudsing. Perforated films render the placement of the film inefficient and allow too much water to pass through the wipe. Ultimately another control agent must be added on top of the physical barrier. Water-soluble film encapsulation of surfactant can render the surfactant unavailable or on the other extreme prevent only initial suds from forming but upon film dissolution do not control surfactant release. Alternatively, the cleaning composition itself may be formulated such that water solubilisation of the composition is slowed. For example the composition may be formulated with a thickening polymer. However thickening polymers change the composition rheology to the point where the composition becomes difficult to process and can no longer be extruded onto the substrate surface during manufacturing. Thickening polymers can also interfere with the stability of foam generated and result in rapid collapse especially if the polymer is rendered insoluble during processing. It behaves more like a particle. These particles if formed can block the manufacturing equipment. Surprisingly the Applicants have found that the level of moisture in the cleaning composition has an effect on the solubility of the cleaning composition itself. Although not wishing to be bound by theory it is believed that the moisture level in the cleaning composition affects the solubility state of the surfactants present in the cleaning composition. At low levels of moisture in the composition or paste, all available moisture is bound to the surfactant and thus the surfactant is found in the crystalline hydrate phase which has low solubility. Upon addition of further water a phase transition occurs. This involves further hydration of the crystal dihydrate (XW₂) phase surfactant and conversion into hexagonal H□ phase. Before free surfactant can be obtained, further water needs to be added to solubilize the hexagonal phase surfactant. The surfactant must therefore pass through two phase transition steps, into two insoluble phases before a soluble surfactant phase is reached. The kinetics of these steps is very slow. The result is slowed solubilisation, and thus release, of the surfactant into the wash water.

Preparing a cleaning composition with low moisture content can theoretically be achieved in two ways. One way is to add a water transfer agent to the composition, which would attract and retain the moisture, allowing the surfactants to form the hexagonal and/or crystal hydrate phases. However this route has not proved efficient. An alternative route is to dry either the surfactant or the cleaning composition containing the surfactant. The preparation of a low moisture cleaning composition however, has not proved as easy as one might expect. Sulphate surfactant-containing compositions are at risk of reversion reaction at high temperature when an acid is present. Hence any amount of acid present during the drying process forces the reversion reaction and producing the alcohol, sulphate and more acid. The free acid catalyses the reaction further. The solution to this finding is to dry the sulphate surfactant-containing composition in the presence of a suitable buffer.

### SUMMARY OF THE INVENTION

According to the present invention there is provided a wipe comprising a water-insoluble substrate and a cleaning composition, said cleaning composition comprising from 1% to 15% water, a sulphate-containing surfactant and a buffer.

According to another aspect of the present invention there is also provided a process of drying a sulphate-containing surfactant comprising heating the surfactant in a thin film evaporator to a temperature of 70 to 200° C. in the presence of a buffer, for a residence time of 10 minutes.

### DETAILED DESCRIPTION OF THE INVENTION

As used herein, “disposable” is used in its ordinary sense to mean an article that is disposed or discarded after a limited number of usage events, preferably less than about 25, more preferably less than about 10, and most preferably less than about 2 usage events. For example, a usage event in a hand dishcare operation is defined as being the cleaning by hand dishwashing of a load of dishes that accumulates during one day in a four person family household.

The wipes of the present invention are preferably water-activated and are therefore intended to be moistened with water prior to use. As used herein, “water-activated” means that the present invention is presented to the consumer in substantially dry form and/or dry-to-the-touch form to be used after wetting/moistening with water. Accordingly, the article is moistened by contacting it with water, including dipping or immersion in water or by placing it under a stream of water.

The wipes according to the present invention may have a length of from about 10 to about 20 cm, a width of from about 10 to about 20 cm and a thickness of from about 2 to about 5 mm.

The wipes of the present invention comprise a water insoluble substrate, which preferably comprises at least two layers, a cleaning layer and a scrubbing layer. The layers herein have an interior and exterior surface. In both cases, the interior surfaces of the layers are those which face the inside portion of the wipe. Whereas the exterior surfaces of the layers are those which face the outside portion of the wipe. Indeed, in one embodiment the two interior sides or surfaces of said cleaning and said scrubbing layer face each other and are positioned adjacent to each other. However, as described herein below one or more additional layers may be present between said cleaning and said scrubbing layer. These additional layers, when present, are sandwiched between said cleaning and said scrubbing layer.

The substrate layers of the wipe are designed for different applications and thus preferably have different textures. The cleaning layer is designed to be used to wipe soil from the surface being cleaned and clean delicate surfaces. The scrubbing layer is designed for scrubbing tough to remove soils, such as burnt-on, baked-on soils. The scrubbing layer is therefore comparatively more abrasive than the cleaning layer.

The cleaning layer and scrubbing layers, as well as any additional layers, are preferably bonded to one another in order to maintain the integrity of the wipe. The layers are preferably heat spot bonded together more preferably using heat generated by high pressure welding. The bonding may be arranged such that geometric shapes and patterns, e.g. diamonds, circles, squares, etc., are created on the exterior surfaces of the layers and the resulting wipe.

The substrate is preferably flexible and even more preferably the substrate is also resilient, meaning that once applied external pressure has been removed the substrate regains it's original shape.

The disposable dish care and hard surface cleaning wipe of the present invention preferably comprise the following components:

The Cleaning Layer

The cleaning layer of the present wipe comprises a cleaning substrate. Said cleaning substrate is preferably composed of nonwoven fibres or paper. The cleaning substrate is preferably partially or fully permeable to water and the cleaning composition.

The cleaning substrate may comprise natural or synthetic fibres. Preferred examples of natural fibres include keratin fibres and cellulosic fibres, including wood pulp, cotton, hemp, jute, fax and combinations thereof. Natural material nonwovens useful in the present invention may be obtained from a wide variety of commercial sources.

As used herein, “synthetic” means that the materials are obtained primarily from various man-made materials or from natural materials that have been further altered. Preferred examples of suitable synthetic materials include acrylics such as acrilan, creslan, and the acrylonitrile-based fiber, orlon; cellulose ester fibers such as cellulose acetate, arnel, and acele; polyamides such as nylons (e.g., nylon 6, nylon 66, nylon 610, and the like); polyesters such as fortrel, kodel, and the polyethylene terephthalate fiber, polybutylene terephalate fiber, dacron; polyolefins such as polypropylene, polyethylene; polyvinyl acetate fibers and combinations thereof.

Preferred polyolefin fibers are fibers selected from the group consisting of polyethylene, polypropylene, polybutylene, polypentene, and combinations and copolymers thereof. Preferred polyester fibers are fibers selected from the group consisting of polyethylene terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), hollow fibers and combinations thereof. Preferred fibers include bicomponent fibers, multiconstituent fibers, and combinations thereof. Such bicomponent fibers may have a core-sheath configuration or a side-by-side configuration. In either instance, the first layer may comprise either a combination of fibers comprising the above-listed materials or fibers which themselves comprise a combination of the above-listed materials.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed.

In addition to the fibres used to make the substrate, the substrate can comprise other components or materials added thereto as known in the art, including binders, dry strength and lint control additives.

In one preferred embodiment the cleaning substrate is made from a lofty substrate, more preferably a batting substrate. Batting is defined according to the TAPPI Association of the Nonwoven Fabrics Industry as a soft bulky assembly of fibres. Batting preferably comprises synthetic materials. Suitable synthetic materials include, but are not limited to, acetate fibers, acrylic fibers, cellulose ester fibers, modacrylic fibers, polyamide fibers, polyester fibers, polyolefin fibers, polyvinyl alcohol fibers, rayon fibers, and combinations thereof. Preferred synthetic materials, particularly fibers, may be selected from the group consisting of nylon fibers, rayon fibers, polyolefin fibers, polyester fibers, and combinations thereof. Preferred polyolefin fibers are fibers selected from the group consisting of polyethylene, polypropylene, polybutylene, polypentene, and combinations and copolymers thereof. More preferred polyolefin fibers are fibers selected from the group consisting of polyethylene, polypropylene, and combinations and copolymers thereof. Preferred polyester fibers are fibers selected from the group consisting of polyethylene terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Most preferred synthetic fibers comprise solid staple polyester fibers that comprise polyethylene terephthalate homopolymers. Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Such bicomponent fibers may have a core-sheath configuration or a side-by-side configuration. In either instance, the batting may comprise either a combination of fibers comprising the above-listed materials or fibers which themselves comprise a combination of the above-listed materials. In any instance, side-by side configuration, core-sheath configuration, or solid single component configuration, the fibers of the batting may exhibit a helical or spiral or crimped configuration, particularly the bicomponent type fibers.

Preferred fibers of the cleaning substrate are those susceptible of heat sealing. In a particularly preferred embodiment the cleaning substrate comprises a combination of single component and bicomponent fibres. More specifically it is preferred that the cleaning substrate comprises polyester single component fibres and polyester core, polyethylene sheath bicomponent fibres.

The batting may also comprise natural fibers.

Furthermore, the fibers of the batting may be of varying sizes, i.e., the fibers of the batting may comprise fibers having different average thicknesses. Also, the cross section of the fibers can be round, flat, oval, elliptical or otherwise shaped.

In another preferred embodiment of the present invention the cleaning substrate is a partially hydrophobic nonwoven. By “partially hydrophobic” it is meant herein that the nonwoven at least partially comprises hydrophobic material. Preferably the nonwoven substrate comprises at least about 40%, more preferably at least about 50%, even more preferably from about 55% to about 75% hydrophobic material.

Hydrophobic materials are generally based on synthetic organic polymers. Suitable hydrophobic materials herein are selected from the group consisting of synthetic organic polymers such as, acrylic fibers, modacrylic fibers, polyamide fibers, polyester fibers, polyolefin fibers, polyethylene foam, polyurethane foam, and combinations thereof. Examples of suitable synthetic materials include acrylics such as acrilan, creslan, and the acrylonitrile-based fiber, orlon; polyamides such as nylons (e.g., nylon 6, nylon 66, nylon 610, and the like); polyesters such as fortrel, kodel, and the polyethylene terephthalate fiber, polybutylene terephthalate fiber, dacron; polyolefins such as polypropylene, polyethylene, and polyurethane foams. Preferably, said hydrophobic materials herein are selected from the group consisting of polyamides, polyethylene terephthalate, and polyolefins. More preferably said partially hydrophobic nonwoven of said cleaning layer comprises polypropylene and rayon fibres.

Hydrophobic materials suitable for the cleaning layer are selected from the group consisting of cellulosic nonwovens, non-lofty nonwovens, and absorbent nonwovens and combinations thereof. Preferably the substrate of the cleaning layer in this emodiement is a non-lofty nonwoven substrate.

The substrate preferably has a weight of from about 20 gm⁻² to about 200 gm⁻². More preferably, the substrate has a weight of at least about 20 gm⁻² and more preferably less than about 150 gm⁻², more preferably the base weight is in the range of about 20 gm to about 120 gm⁻², and most preferably from about 30 gm to about 110 gm⁻². The substrate may have any caliper. Typically, when the substrate is made by hydroentangling, the average substrate caliper is less than about 1.2 mm at a pressure of about 0.1 pounds per square inch. More preferably the average caliper of the substrate is from about 0.1 mm to about 1.0 mm at a pressure of about 0.1 pounds per square inch (about 0.007 kilograms per square meter). The substrate caliper is measured according to standard EDANA nonwoven industry methodology, reference method # 30.4-89.

In the most preferred embodiment according to the present invention said cleaning layer is a carded, spunlaced partially hydrophobic nonwoven.

In another preferred embodiment according to the present invention said partially hydrophobic nonwoven of said cleaning layer consists of at least about 40%, preferably of from about 50% to about 75%, more preferably of from about 55% to about 65% of synthetic fibres.

In a preferred embodiment the wipe comprises at least two different cleaning substrates, meaning that the composition of each cleaning substrate differs from the other. Preferably the different cleaning substrates are selected for their disposability, absorbency and suds generating characteristics. The Applicants have found that whereas paper substrates are generally the most biodegradable and thus the preferred substrate material for disposability, they are not preferred for absorbency or suds generation. By contrast nonwoven substrates, especially batting substrates have excellent suds generation abilities, but are less biodegradable and thus less disposable than paper substrates. It is thus preferred to employ different cleaning substrates, so as to produce a wipe which exhibits all characteristics. In one preferred aspect the wipe comprises two cleaning substrates, a paper substrate and a nonwoven substrate, preferably a lofty, more preferably a batting substrate.

The Scrubbing Substrate

As defined above, the scrubbing substrate provides a comparatively more abrasive surface than the cleaning substrate and as such is useful in scrubbing food residue/soil, especially tough to remove residue/soil, from dishware. The abrasive nature may be provided by a substrate which is inherently abrasive or a substrate wherein the abrasiveness is provided by additional elements adhered or in some way fixed to the substrate.

In one embodiment of the present invention the scrubbing substrate comprises an abrasive net of fibres, otherwise known as a scrim. By the term ‘net’ it is meant a structure made directly from melts or fibres which are at least 0.2 mm long and are held together by systems other than hydrogen bonding. The fibres may be selected from metal, natural or synthetic wires, filaments or stands or mixtures thereof as long as the resulting web provides a surface which is more abrasive than the cleaning substrate. Preferred fibres are selected from those of synthetic organic origin, more preferably from polymeric synthetic organic origin and thermoplastic polymers. The fibres are preferably selected from polyamide, polyethylene, polypropylene fibres and mixtures thereof.

The fibres may be randomly arranged, but are preferably ordered. The net may be made using any known process, including those described above for preparing nonwoven substrates. In a preferred embodiment the fibres are arranged in an open lattice wherein the fibres are, for example, knitted or extruded together to form the net. In a particularly preferred embodiment of the present invention the scrubbing substrate comprises a polymeric mesh, scrim or combinations thereof. By the term “macroscopically expanded, we mean webs which have been caused to conform to the surface of a three-dimensional forming structure so that both surfaces thereof exhibit a three-dimensional forming pattern of surface aberrations corresponding to the macroscopic cross-section of the forming structure, wherein the surface aberrations comprising the pattern are individually discernible to the normal naked eye (i.e., normal naked eye having 20/20 vision) when the perpendicular distance between the viewer's eye and the plane of the web is about 12 inches. For example the web may be embossed, meaning that the web exhibits a pattern comprised primarily of male projections. On the other hand, the web may be debossed, meaning that the web exhibits a pattern comprised primarily of female capillary networks. As with the cleaning substrate it is highly preferred that the scrubbing substrate is flexible and even more preferably the substrate is also resilient meaning that once applied pressure has been removed the substrate regains it's original shape.

Where the above type of scrubbing layer is used it is preferable to employ two or more scrubbing substrates. As discussed above, the wipe may also comprise more than one cleaning substrate. Most preferably the substrates are arranged one on top of the other in a layered fashion, one of the scrubbing substrates being in contact with the cleaning substrate.

Alternatively the scrubbing layer may comprise a substrate which is prepared by embossing or debossing thereby creating an uneven undulating surface which is inherently more abrasive than the cleaning layer. In this embodiment it is preferred that the most abrasive side faces away from the cleaning substrate, so as to present the most abrasive surfaces for cleaning. Where more than one scrubbing substrate is used, it is preferred that the scrubbing substrates are attached to one another, such that at least a portion, preferably the majority of the scrubbing substrates, can move independently of one another.

In another alternative embodiment the scrubbing layer is a low density nonwoven. Preferably, said scrubbing layer is a batting layer. By ‘batting layer’ it is meant herein a nonwoven structure of high loft, resiliency and low density. By ‘low density’ or lofty nonwoven it is meant herein that the layer has a density of from about 0.00005 g/cm³ to about 0.1 g/cm³, preferably from about 0.001 g/cm³ to about 0.09 g/cm³ and a thickness of from about 0.04 inches to about 2 inches at 5 gms/in².

In order to make said substrate sufficiently abrasive so as to perform as the scrubbing layer of the present invention, a layer of thermoplastic nubs or hooks are melded onto one surface of the substrate. Said substrate is then attached to the cleaning layer such that the surface comprising the nubs or hooks faces away from the cleaning layer.

In a preferred embodiment according to the present invention said nubs/hooks comprising layer has a loft of at least about 1 mm, preferably of from about 2 mm to about 4 mm. In another preferred embodiment according to the present invention said nubs/hooks comprising layer has a density of from about 0.00005 g/cm³ to about 0.1 g/cm³, preferably from about 0.001 g/cm³ to about 0.09 g/cm³.

Materials suitable for the nubs/hooks comprising layer are selected from the group consisting of both natural and synthetic fibers or materials. Suitable natural materials are the same as described herein above in the section titled ‘Cleaning Layer’. Suitable synthetic materials are the same as described herein above in the section titled ‘Cleaning Layer’.

Preferred substrates comprise polyolefin fibers are fibers selected from the group consisting of polyethylene, polypropylene, polybutylene, polypentene, and combinations and copolymers thereof. More preferred polyolefin fibers are fibers selected from the group consisting of polyethylene, polypropylene, and combinations and copolymers thereof. Preferred polyester fibers are fibers selected from the group consisting of polyethylene terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Most preferred synthetic fibers of the second layer comprise solid staple polyester fibers, which comprise polyethylene terephthalate homopolymers. Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Preferred fibers include bicomponent fibers, multiconstituent fibers, and combinations thereof. Such bicomponent fibers may have a core-sheath configuration or a side-by-side configuration. In either instance, the second layer may comprise either a combination of fibers comprising the above-listed materials or fibers which themselves comprise a combination of the above-listed materials.

Methods of making nonwovens are well known in the art. Generally, these nonwovens can be made as described herein above in the section titled ‘Cleaning Layer’.

Low density nonwoven made from synthetic materials useful in the present invention can be obtained from a wide variety of commercial sources. Suitable materials useful herein include Sorbifelt 14®, a material, having a basis weight of about 120 grams per square meter (gsm), a density of about 0.006 g/cm³ and a loft of about 2 mm commercially available from Libeltex; Air laid nonwovens material, having a basis weight of about 80 grams per square meter (gsm), a density of about 0.008 g/cm³ and a loft of about 1 mm are commercially available from Concert; and Chicopee 4202®, a material, having a basis weight of about 85 grams per square meter (gsm), a density of about 0.005 g/cm³ and a loft of about 1.6 mm commercially available from Chicopee.

In a preferred embodiment according to the present invention said low-density nonwoven consists of polyethylene terephthalate (PET), and bicomponent sheath core fibers made from polyethylene (PE) and polyethylene terephthalate (PET).

In a preferred embodiment according to the present invention said second layer is made of a high loft, low density nonwoven preferably carded through air bonded structure. In this embodiment it is also preferable that the cleaning substrate is also a lofty nonwoven.

As described above the scrubbing substrate of this embodiment comprises nubs or hooks made of thermoplastic material. By the nubs or hooks being melded onto the scrubbing layer it is meant herein that a thermoplastic material-melt is applied onto the exterior surface of the scrubbing substrate in the form of preferably rounded protuberances or spheres, having a substantially globular shape. When cooling, the second layer-facing portion of said thermoplastic material melt forms a bond with the fibers of the scrubbing substrate. The nubs or hooks formed by the hardened thermoplastic material provide abrasiveness, which during use in a dishcare or hard surface cleaning operation facilitates the removal of soil for the surface to be cleaned.

A suitable thermoplastic material for use as abrasive coating is selected from the group consisting of thermoplastic polymers preferably including: polyethylene and polyethylene copolymer; polypropylene; and polyethylene terephthalate. Preferably, said thermoplastic material is a hot melt adhesive. Suitable hot melt adhesives are commercially available from HB Fuller under the trade names NW1034® or HL1014X®. Furthermore, suitable hot melt adhesives are commercially available under the trade name H2128® from Ato Findley.

Preferably said nubs or hooks have a substantially globular shape having a diameter of at least about 200 micro-meter, preferably a diameter of from about 300 to about 600 micro-meter, more preferably of from about 300 to about 500 micrometer.

In a preferred embodiment, the nubs or hooks are applied onto the scrubbing substrate in a regular pattern. Preferably, the nubs or hooks are applied onto the scrubbing substrate in a regular pattern formed by a multitude of rows of nubs or hooks, wherein neighboring rows are applied in a way so that they are offset, i.e., the smaller angle between a row of nubs or hooks (base row) and the line formed by connecting a nub or hook in the base row and a neighboring nub or hook (i.e., a nub or hook in a neighboring row), is preferably about 45°.

The abrasive coating of thermoplastic material nubs or hooks is preferably applied onto said scrubbing substrate by screen printing.

In a preferred embodiment according to the present invention, the abrasive coating of thermoplastic material has a lower melting point than the low density nonwoven of said scrubbing substrate. It has been found that this provides the additional benefit of avoiding partially melting the scrubbing substrate whilst applying the thermoplastic material in the form of a hot melt.

The cleaning and scrubbing substrates are preferably attached, potentially reversibly attached, to one another. The point of attachment can be at any point over the surface of the wipe, as long as the scrubbing substrate(s) and cleaning substrate(s) are attached to one another. Even more preferably the cleaning and scrubbing substrates are attached to one another around the perimeter of the scrubbing and/or cleaning substrates. The substrates may be attached to one another using any commonly known method, for example using heat sealing, adhesive, ultrasonic sealing, stitching and combinations thereof. Preferably the substrates are attached to one another using heat sealing. Even more preferably the substrates are attached to one another, by a combination of heat sealing around the perimeter of the substrate and dot heat sealing, preferably in a pattern, across the surface area of the wipe. This latter method of heat sealing is described in more detail in the embodiment comprising a partially or fully water impermeable membrane. Where heat sealing is used, it is necessary that the cleaning and/or scrubbing substrate comprise thermoplastic polymers. The greater the content of thermoplastic polymers the stronger is the sealing.

Additional Layers

Optionally, the substrate herein may comprise one or more optional layers located between said cleaning layer and said scrubbing layer.

In a preferred embodiment according to the present invention, the water insoluble substrate herein additionally comprises a third substantially water-impermeable layer located in-between said cleaning layer and said scrubbing layer.

By ‘substantially water-impermeable’ it is meant herein that the layer has a low but not significant level of permeability for water.

Preferably, said third substantially water-impermeable layer is a plastic film more preferably a plastic film made from linear low density polyethylene (LDPE) and metallocene catalyzed low density polyethylene. Preferably, said plastic film has a thickness of about 0.8 mm. Preferably, said third water-impermeable layer has an embossed micropattern. It has been found that such an embossed micropattern provides low noise during use. A suitable material for said water-impermeable layer is commercially available from Tregedar under the trade name EMB-685®.

Cleaning Composition

The wipes of the present invention further comprise a cleaning composition. All levels (weight %) of the ingredient(s) of the cleaning composition as well as the rheological values herein are given for the cleaning composition as applied onto one or a multitude of the layers of the substrate herein. It has been observed, that upon storage solvents, such as water, when present, or other volatile compounds, when present, may evaporate. This will lead to an increase in the concentration of the non-evaporating compound(s) of the cleaning composition. Furthermore, the solvents, when present, evaporation will lead to a change in the rheology and morphology of said cleaning composition.

In a preferred aspect of the present invention the composition is in the form of a paste. By ‘paste’ it is meant herein that the material is in a solid state and does not continuously change its shape when subjected to a given yield stress preferably of at least 160 Pa (see An Introduction to Rheology, H. A. Barnes, et. al.). The cleaning paste flows under increased pressure and has a reduction in viscosity by its increasing temperature.

Said rheological properties include but are not limited to a high yield value, shear sensitive viscosity profile, and desired viscoelastic properties for processing and consumer use. Preferably, the cleaning paste has a yield stress of at least about 160 Pa, more preferably of from about 250 Pa to about 1000 Pa.

By ‘yield stress’ it is meant herein the amount of pressure required to initiate flow of the cleaning paste. The yield stress of a given cleaning paste can be measured by using a cone and plate rheometer. A Rheometrics SR-200® fitted with a 40 mm HDPE (0.4 radian) cone and a 316SS® stainless Peltier plate at a 0.0483 mm gap (based upon the 0.4 radian cone's truncation height) operated at a temperature of 20° C. at atmospheric temperature and pressure. The yield stress is obtained by plotting from rest (up curve) shear rate/shear stress on the y-axis by the shear stress on the x-axis as described in A Comparison of Techniques for Measuring Yield Stresses by A. S. Yoshimura and R. K. Prud'homme (Journal of Rheology 31(8); 1987). The yield stress is then obtained by plotting a line whereby the yield stress or yield point is found at the deviation from that linear behavior.

Preferably, the cleaning paste has a Power Law viscosity profile: consistency (K) from about 30000 to about 10000000 and a shear index (n) from about 0.50 to about 0.20. More preferably, the cleaning paste has a Power Law viscosity profile of K from about 200000 to about 3500000 and n from about 0.25 to about 040.

By ‘Power Law, Consistency, and shear index’ it is meant herein the shear behavior under stress as measured from a plot of shear rate or strain by the viscosity. The shear behavior of a given cleaning paste can be measured by using a cone and plate rheometer. A Rheometrics SR-200® fitted with a 40 mm HDPE (0.4 radian) cone and a 316SS® stainless Peltier plate at a 0.0483 mm gap (based upon the 0.4 radian cone's truncation height) operated at a temperature of 20° C. at atmospheric temperature and pressure. The shear behavior is obtained by plotting using shear viscosity data as stress is taken away (down curve) by plotting viscosity on the y-axis by the shear rate on the x-axis as described in Rheology: Principles, Measurements, and Applications by C. W. Macosko (VCH Publishers, 1994). The shear behavior is then obtained by running a regression of a logarithmic-logarithmic plot using linear regression to obtain the consistency (K) value from the y-intercept and the shear index (n) from the slope of said plot.

The rheological properties of the cleaning paste are tailored to meet specific product requirements and consumer habits. In particular, several surfactant release issues of the cleaning paste are: controlling water ingress & subsequent aqueous surfactant solution migration to the surface to be cleaned, extrusion of surfactant cells leading to waste, and smearing of surfactant during scrubbing yielding a less desired fast surfactant release profile. In order to reduce smearing and extrusion of the surfactant leading to undesired waste, the yield value of the cleaning paste, the amount of pressure required to initiate flow, should be near the upper range of the highest pressure exerted on the wipe during use. The shear versus viscosity effect should be such that water ingress is reduced by the layer's viscosity increase but that the surfactant paste can smear to the desired extent to release an aqueous surfactant solution for cleaning.

The cleaning composition, preferably cleaning paste herein may be applied onto said cleaning layer, said scrubbing layer and/or optional additional layer(s), when present. Furthermore, the cleaning composition herein may be applied onto the interior and/or exterior surfaces of one or several layer(s) of the substrate of the wipe according to the present invention.

Preferably, the cleaning composition is applied onto said scrubbing layer, more preferably the cleaning composition herein is applied onto said scrubbing layer on the side facing said cleaning layer. Indeed, the cleaning composition is most preferably deposited onto the interior surface of the scrubbing layer.

The cleaning composition herein may be equally distributed over the full surface of the layer(s) it is deposited on or applied onto a part of the surface of the layer(s) it is deposited on. Preferably, said cleaning composition is applied onto a part of the surface of the layer(s) it is deposited on, more preferably said cleaning composition is applied onto a part of the surface of said second layer.

In a preferred embodiment according to the present invention, the cleaning composition is applied onto parts of at least one of the layers herein, preferably said second layer, by a stripe pattern. More preferably, said stripe pattern has at least about 1 stripe, preferably of from about 1 to about 6 stripes, more preferably about 3 to about 6 stripes, and even more preferably about 5 stripes. Preferably, the stripe or stripes of the stripe pattern extend over the full length of the substrate. The stripe or stripes of the stripe pattern may have a width of at least about 3 mm, preferably of from about 5 mm to about 15 mm.

In a preferred embodiment herein, the cleaning composition herein covers at least about 30% of the surface of at least one of the layers herein, preferably of said second layer, more preferably of the surface of said second layer facing said first layer, preferably, the cleaning composition herein covers of from about 40% to about 60% of the surface of at least one of the layers herein, preferably of said second layer, more preferably of the surface of said second layer facing said first layer.

The wipes of the present invention comprise from about 10% to about 1,000%, preferably from about 50% to about 600%, and more preferably from about 100% to about 250%, based on the weight of the water insoluble substrate, of the cleaning composition. The wipes of the present invention preferably comprise at least about 4.5 grams of said cleaning composition.

Surfactant

The cleaning composition of the present invention comprises a sulfate-containing surfactant or a mixture thereof. The cleaning composition preferably comprises said sulphate-containing surfactant in an amount of 30% to 80% by weight of the cleaning composition. More preferably said cleaning composition comprises said sulphate-containing surfactant at a level of from 40% to 70% and most preferably from 50% to 70%.

Suitable sulfate-containing surfactants for use in the compositions herein include water-soluble salts or acids of the formula ROSO₃M wherein R preferably is a C₆-C₂₀ linear or branched hydrocarbyl, preferably an alkyl or hydroxyalkyl having a C₁₀-C₂₀ alkyl component, more preferably a C₁₀-C₁₄ alkyl or hydroxyalkyl, and M is H or a cation, e.g., an alkali metal cation or ammonium or substituted ammonium, but preferably sodium.

Suitable sulfate-containing surfactants for use herein are water-soluble salts or acids of the formula RO(A)ₘSO₃M wherein R is an unsubstituted linear or branched C₆-C₂₀ alkyl or hydroxyalkyl group having a C₁₀-C₂₀ alkyl component, preferably a C₁₂-C₂₀ alkyl or hydroxyalkyl, more preferably C₁₂-C₁₄ alkyl or hydroxyalkyl, A is an ethoxy or propoxy unit, m is greater than zero, typically between about 0.5 and about 5, more preferably between about 0.5 and about 2, and M is H or a cation which can be, for example, a metal cation, ammonium or substituted-ammonium cation. Alkyl ethoxylated sulfates as well as alkyl propoxylated sulfates are contemplated herein. Exemplary surfactants are C₁₀-C₁₄ alkyl polyethoxylate (1.0) sulfate, C₁₀-C₁₄ polyethoxylate (1.0)sulfate, C₁₀-C₁₄ alkyl polyethoxylate (2.25) sulfate, C₁₀-C₁₄ polyethoxylate (2.25) sulfate, C₁₀-C₁₄ alkyl polyethoxylate (3.0) sulfate, C₁₀-C₁₄ polyethoxylate (3.0) sulfate, and C₁₀-C₁₄ alkyl polyethoxylate (4.0) sulfate, C₁₀-C₁₈ polyethoxylate (4.0) sulfate. In a preferred embodiment the anionic surfactant is a mixture of alkoxylated, preferably ethoxylated and non-alkoxylated sulfate surfactants. In such a preferred embodiment the preferred average degree of alkoxylation is from about 0.4 to about 0.8.

The sulphate-containing surfactants of the present invention are preferably dried in a thin film evaporator as can be found in the field. The surfactant is heated to a temperature of between 70 to 200° C. in the presence of a buffer as described below, for a residence time of 10 minutes.

Additional Surfactants

The cleaning composition may also comprise additional surfactants, selected from other anionic surfactants, amphoteric surfactant, nonionic surfactant, and zwitterionic surfactant, and mixtures thereof.

Other particularly suitable anionic surfactants for use herein are alkyl sulphonates including water-soluble salts or acids of the formula RSO₃M wherein R is a C₆-C₂₀ linear or branched, saturated or unsaturated alkyl group, preferably a C₁₀-C₂₀ alkyl group and more preferably a C₁₀-C₁₄ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₀ linear or branched saturated or unsaturated alkyl group, preferably a C₁₂-C₁₆ alkyl group and more preferably a C₁₀-C₁₄ alkyl group, and M is H or a cation, e.g., an alkali metal cation (e.g., sodium, potassium, lithium, calcium, magnesium etc) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

In a further preferred embodiment the carbon chain of the anionic surfactant comprises alkyl, preferably C₁₋₄ alkyl branching units. The average percentage branching of the anionic surfactant is greater than about 30%, more preferably from about 35% to about 80% and most preferably from about 40% to about 60%. Such average percentage of branching can be achieved by formulating the composition with one or more anionic surfactants all of which are preferably greater than 30% branched, more preferably from about 35% to about 80% and most preferably from about 40% to about 60%. Alternatively and more preferably, the composition may comprise a combination of branched anionic surfactant and linear anionic surfactant such that on average the percentage of branching of the total anionic surfactant combination is greater than about 30%, more preferably from about 35% to about 80% and most preferably from about 40% to about 60%.

Other additional anionic surfactants useful for detersive purposes can also be used herein. These can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, sulphobetaines, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23 (herein incorporated by reference).

Other particularly suitable anionic surfactants for use herein are alkyl carboxylates and alkyl alkoxy carboxylates having from about 4 to about 24 carbon atoms in the alkyl chain, preferably from about 8 to about 18 and more preferably from about 8 to about 16, wherein the alkoxy is propoxy and/or ethoxy and preferably is ethoxy at an alkoxylation degree of from about 0.5 to about 20, preferably from about 5 to about 15. Preferred alkyl alkoxy carboxylate for use herein is sodium laureth 11 carboxylate (i.e., RO(C₂H₄O)₁₀—CH₂COONa, with R=C12-C14) commercially available under the name Akyposoft® 100NV from Kao Chemical GmbH.

Amphoteric surfactants are preferred additional surfactants. The amphoteric surfactants useful in the present invention are preferably selected from amine oxide surfactants. Amine oxides are semi-polar nonionic surfactants and include water-soluble amine oxides containing one alkyl moiety of from about 10 to about 18 carbon atoms and about 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and about 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Semi-polar nonionic detergent surfactants include the amine oxide surfactants having the formula 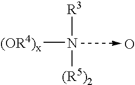
wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

Also suitable are amine oxides such as propyl amine oxides, represented by the formula: 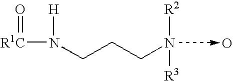
wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula: 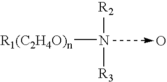
wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. Particularly preferred are amine oxides of the formula: 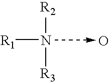
wherein R₁ is a C₁₀₋₁₄ alkyl and R₂ and R₃ are methyl or ethyl. Because they are low-foaming it may also be desirable to use long chain amine oxide surfactants, which are more fully described in U.S. Pat. No. 4,316,824 (Pancheri), U.S. Pat. No. 5,075,501 and U.S. Pat. No. 5,071,594, incorporated herein by reference.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from about 8 to about 24 carbon atoms and at least one aliphatic substituent contains an anionic water-solubilizing group.

Further examples of suitable amphoteric surfactants are given in “Surface Active Agents and Detergents” (Vol. I and II by Schwartz, Perry and Berch), hereby incorporated by reference.

Suitable nonionic detergent surfactants are generally disclosed in U.S. Pat. No. 3,929,678, Laughlin et al., issued Dec. 30, 1975, at column 13, line 14 through column 16, line 6, incorporated herein by reference.

The condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include Tergitol® 15-S-9 (the condensation product of C₁₁-C₁₅ linear secondary alcohol with about 9 moles ethylene oxide), Tergitol® 24-L-6 NMW (the condensation product of C₁₂-C₁₄ primary alcohol with 6 moles ethylene oxide with a narrow molecular weight distribution), both marketed by Union Carbide Corporation; Neodol® 45-9 (the condensation product of C₁₄-C₁₅ linear alcohol with about 9 moles of ethylene oxide), Neodol® 23-6.5 (the condensation product of C₁₂-C₁₃ linear alcohol with about 6.5 moles of ethylene oxide), Neodol® 45-7 (the condensation product of C₁₄-C₁₅ linear alcohol with about 7 moles of ethylene oxide), Neodol® 45-4 (the condensation product of C₁₄-C₁₅ linear alcohol with about 4 moles of ethylene oxide), marketed by Shell Chemical Company, and Kyro® EOB (the condensation product of C₁₃-C₁₅ alcohol with about 9 moles ethylene oxide), marketed by The Procter & Gamble Company. Other commercially available nonionic surfactants include Dobanol 91-8® marketed by Shell Chemical Co. and Genapol UD-080® marketed by Hoechst. This category of nonionic surfactant is referred to generally as “alkyl ethoxylates.”

The preferred alkylpolyglycosides have the formula
R²O(CₙH₂ₙO)ₜ(glycosyl)ₓ
wherein R² is selected from the group consisting of alkyl, alkyl-phenyl, hydroxyalkyl, hydroxyalkylphenyl, and mixtures thereof in which the alkyl groups contain from about 10 to about 18, preferably from about 12 to about 14, carbon atoms; n is about 2 or about 3, preferably about 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants having the formula: 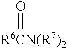
wherein R⁶ is an alkyl group containing from about 7 to about 21 (preferably from about 9 to about 17) carbon atoms and each R⁷ is selected from the group consisting of hydrogen, C₁-C₄ alkyl, C₁-C₄ hydroxyalkyl, and —(C²H₄O)ₓH where x varies from about 1 to about 3.

Preferred amides are C₈-C₂₀ ammonia amides, monoethanolamides, diethanolamides, and isopropanolamides.

The detergent compositions hereof may also contain a polyhydroxy fatty acid amide surfactant. The polyhydroxy fatty acid amide surfactant component comprises compounds of the structural formula: 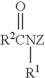
wherein: R¹ is H, C₁-C₄ hydrocarbyl, 2-hydroxy ethyl, 2-hydroxy propyl, or a mixture thereof, preferably C₁-C₄ alkyl, more preferably C₁ or C₂ alkyl, most preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, most preferably straight chain C₁₁-C₁₅ alkyl or alkenyl, or mixtures thereof; and Z is a polyhydroxyhydrocarbyl having a linear hydrocarbyl chain with at least about 3 hydroxyls directly connected to the chain, or an alkoxylated derivative (preferably ethoxylated or propoxylated) thereof. Z preferably will be derived from a reducing sugar in a reductive amination reaction; more preferably Z will be a glycityl. Suitable reducing sugars include glucose, fructose, maltose, lactose, galactose, mannose, and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ-1-CH₂OH, —CH₂—(CHOH)₂(CHOR′)(CHOH)—CH₂OH, and alkoxylated derivatives thereof, where n is an integer from about 3 to about 5, inclusive, and R′ is H or a cyclic or aliphatic monosaccharide. Most preferred are glycityls wherein n is 4, particularly —CH₂—(CHOH)₄—CH₂OH.

R′ can be, for example, N-methyl, N-ethyl, N-propyl, N-isopropyl, N-butyl, N-2-hydroxy ethyl, or N-2-hydroxy propyl.

R²—CO—N<can be, for example, cocamide, stearamide, oleamide, lauramide, myristamide, capricamide, palmitamide, tallowamide, etc.

Z can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

The particular surfactants used can therefore vary widely depending upon the particular end-use envisioned. Suitable additional surfactants are described in detail in the co-pending provisional patent application of Chandrika Kasturi et al., entitled “Liquid Detergent Compositions Comprising Polymeric Suds Enhancers”, having P & G Case No. 6938P, application Ser. No. 60/066,344, incorporated above.

In a preferred embodiment, said surfactant is a mixture of C₁₀₋₁₆ alkylethoxysulfate with an average of about 0.6 moles of ethoxylate, C₁₀₋₁₆ alkyldimethyl amine oxide, C₁₁ alcohol ethoxylate (EO)₉ nonionic surfactant.

The cleaning composition may also comprise of from about 2% to about 15%, preferably of from about 3% to about 10%, and most preferably about 6% by weight of the total cleaning composition of fumed silica. It has been found that the presence of fumed silica aids to bind free water and assists in the aging, drying, and structuring characteristics of the surfactant composition. Suitable fumed silicas are commercially available; an example is Cab-o-Sil M5® from Cabot Corporation.

The surfactant component of the cleaning composition may comprise of from about 15% to about 100%, preferably of from about 20% to about 85%, more preferably of from about 25% to about 60% by weight of the total cleaning composition of surfactant.

Water

The present wipes are dry-to-the-touch or substantially dry-to-the-touch. By ‘dry-to-the-touch’ it is meant that the wipes are substantially free of water or other solvents in an amount that would make them feel damp or wet to the touch as compared to the touch of a wet wipe or pre-moistened wipe, wherein a substrate is impregnated (i.e., soaked) in a liquid.

The wipes according to the present invention preferably remain dry-to-the-touch until it is required for use in cleaning a surface as described herein, this means until they are intentionally moistened with water in the process of cleaning a surface, preferably dishware, according to the present invention.

The cleaning compositions of the present invention comprise from 2 to 15% moisture. More preferably the cleaning composition may comprise of from about 5% to 12% and most preferably from about 8% to 12%. When the moisture level in the cleaning composition is below 1% by weight of the composition, the surfactants form the crystalline anhydrous form. The surfactant is highly soluble at this point as the dissolution of the surfactant is entropically driven When the moisture level in the cleaning composition is above 15% by weight, the surfactants form soluble phases. And thus in both scenarios the surfactants of the composition are more easily dissolved in the wash water.

In one preferred embodiment of the present invention the wipe comprises two different pastes. The first paste comprises moisture at the level according to the present invention. Thus this first paste dissolves in the wash water over the period of use of the wipe. Dosing surfactant into the washwater throughout the use and thus providing the user with sustained suds throughout the wash. The second paste is formulated with a higher level if moisture, 15% to 25% by weight of the composition. As discussed above formulae comprising higher level of moisture, dissolve more readily in the wash water as the surfactants are in a more soluble phase. Hence a wipe comprising a first and second paste as described about provides the user with a high level of immediate suds in the wash water as well as sustained suds throughout the use of the wipe.

As outlined above, water may evaporate from the cleaning composition once applied onto the substrate.

Buffer

The compositions of the present invention comprises a buffer. The buffers used in the present invention must be capable of buffering acids. The buffers thus preferably have pKa of from 6 to 12, more preferably from 8 to 11, most preferably from 8 to 10.5. The buffer may be organic or inorganic.

Organic buffers preferably constitute small organic molecules of molecular weights from 50 to 500 daltons. Buffering functional groups present in organic buffers should include a combination of a basic group with either an acid group or a neutral group. Preferred basic groups include nitrogen-containing groups such as amino and alkyl amino groups.

Preferred acidic groups include carboxylate, sulfate, sulfonate, phosphate and mixtures thereof. Preferred nonionic groups include aldehyde, keto, amido, ester, nitro, cyano, hydroxyl, alkoxyl, alkyl, phosphate, phosphine and phosphate groups. Typical examples of suitable organic buffers include: 1,3 bis aminomethyl cyclohexane diamine, MES (morpholino ethane sulfonic acid), CAPS (cylohexyl amino ethane sulfonic acid) and amino acids such as N,N-bis hydroxyethyl glycine, asparagines and arginine, monoethanolamine, triethanolamine and mixtures thereof.

Inorganic buffers preferably constitute inorganic salts ranging from 50-200 daltons. Examples are alkali and alkaline earth metal carbonates and bicarbonates (e.g. Na2CO3, K2CO3, NaHCO3, MgCO3), alkali metal borates (e.g. sodium borate), alkali metal phosphates (e.g. Na3PO4), alkali silicates/derivatives of silicic acid and mixtures thereof. The pKa range of the inorganic salt must fall within the 6-12 range for the salt form to buffer during drying.

Surfactants can also provide buffering capacity similar to small organic molecules, and are the preferred option as they also deliver surfactant-based performance to the formula such as grease cleaning or sudsing in addition to their buffering capability. As above, the choice of pKa is important for the buffering capacity to work. Particularly preferred surfactant buffers are amphoteric surfactants with pKa in the range of 6 to 12. A highly preferred surfactant for this purpose is amine oxide, which with a pKa of 8.

Zwitterionics such as betaines and sulfobetaines do not have the right pKa to effectively buffer. This is because the amino groups are quaternized and the free carboxylate or sulfate exhibits very weak basicity.

Thickening Polymer

In a preferred embodiment the composition applied to the wipe also comprises a water-soluble thickening polymer. We find that the inclusion of such a polymer has the benefit that the release of bleach from the substrate into the aqueous cleaning environment is controlled.

The polymer has anionic side chains, and/or side chains which are anionic when in the cleaning composition itself, and preferably has a pKa in the range of 4 to 20. Thus the side chains may be acid groups provided that the pKa of those acid groups is sufficiently low that under the pH conditions prevailing in the cleaning composition they are in the sort form. Generally acid groups having pKa 8.5 or below form anionic side chains in the cleaning composition and preferably pKa is not more than 8. Generally it is at least 4 and is preferably from 4 to 7. The side chains can be for instance carboxylate, sulfate or sulfonate and the polymer can be provided to the composition in the acid or the salt form provided that the salt form is present in the composition.

We believe that the inclusion of polymers having anionic side chains is beneficial over use of neutral polymers, at least in part due to the greater ability of anionic polymers to form a network which inhibits dissolution of the surfactant. Benefits also exist over cationic polymers, we believe because the majority of surfactants used in dishwashing cleaning compositions are anionic and the use of anionic polymers prevents excessive complexation between the surfactant and the polymer which might lead to failure to release all of the desired surfactant.

The anionic side chains are preferably carboxylate groups and we find that a particularly preferred class of materials having carboxylate side chains is polysaccharides and polysaccharide derivatives. These give particularly good controlled release results.

Preferred polymers also comprise hydroxyl groups or other groups capable of exhibiting hydrogen bonding, as we believe this contributes to the control of release.

Preferably the polysaccharide or polysaccharide derivative has a molecular weight of 1×10⁵ to 9×10⁷, preferably 5×10⁵ to 5×10⁶.

In another preferred embodiment of the invention, the polysaccharide or polysaccharide derivative is selected from the group consisting of xanthan gum, cellulose, modified celluloses, guar gum and gum arabic and mixtures thereof. Preferably the polysaccharide or polysaccharide derivative is selected from the group consisting of xanthan gum and guar gum. Most preferred is xanthan gum, preferably with a molecular weight of approximately 10⁶. Derivatives of xanthan gum can be used provided they retain the anionic side chains and, preferably, hydroxyl groups.

In another preferred embodiment of the invention, the water-soluble polymer is a polyvinyl alcohol (PVA). The anionic charge is then formed in the composition by deprotonation of the hydroxyl groups, converting them to alkoxide groups having a pKa of between 8 and 14. The PVA preferably has a molecular weight of between 10,000 and 60,000 daltons, and is preferably partially hydrolysed to improve its dispersibility in the cleaning composition. The degree of hydrolysis is preferably 85% to 90%. In the partially hydrolysed form, PVA has both anionic and hydrophobic characteristics that are surfactant-like, resulting in excellent sudsing characteristics. Other preferred polymers that form anionic side chains when in the cleaning composition itself, are polyacrylic acids and polyvinyl pyrrolidone.

The water-soluble thickening polymer may be intimately combined with the surfactant or alternatively may be located in a separate location on the substrate.

Suitable amounts of polymer are in the range from 2 to 12%, preferably from 4 to 8%, more preferably from 5 to 7% by weight, based on weight of composition applied to the substrate.

It is preferred that the level of water soluble thickening polymer is from 3 to 30%, preferably 5 to 25%, based on the weight of peroxy carboxylic acid or precursor bleach in the composition.

Bleach

In all aspects of the invention it is essential that the substrate has applied thereto a composition which comprises a bleach. Any bleach known for detergent use may be used, as appropriate. In the first aspect of the invention the bleach is a peroxy carboxylic acid bleach or a hydrophilic precursor thereof. Preferably the bleach is chosen from aliphatic C₁-C₂₂ peroxy carboxylic acids and precursors thereof, in particular aliphatic C₉ to C₁₆ peroxy carboxylic acids and precursors thereof. Particularly suitable peroxy carboxylic acids in this class include pernonanoic acid, n-nonanoyl-6-aminopercaproic acid and diperoxydodecane dioic acid.

Other preferred bleaches are aromatic C₇ to C₃₀ peroxy carboxylic acids and precursors thereof, preferably C₇ to C₂₀ heteroaromatic peroxy carboxylic acids. Particularly preferred examples include phthalimidoperoxyhexanoic acid (PAP), described in EP-A-349940, and other compounds of the formula: 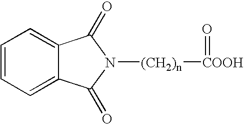
in which n can be from 1 to 18. In PAP n is 5.

Other preferred aromatic bleaches are substituted perbenzoic acids (e.g. meta-chloroperoxybenzoic acid, magnesium monoperoxyphthalate).

The bleach system may also comprise other components such as bleach activators to boost the action of the bleach. Examples of bleach activators are tetracetyl ethylene diamine (TAED), NOBS, acyl triethyl citrate, nonylamide of peradipic acid (e.g. as discussed in U.S. Pat. No. 4,259,201), sodium 3,5,5-trimethylhexanoyloxybenzene sulfonate (e.g. as discussed in U.S. Pat. No. 4,818,425), N-acyl caprolactams (acetoyl-undecanoyl caprolactams), imine and oxaziridine based bleach activators.

In addition, the system may include bleach catalyst to improve oxidation kinetics. Examples of bleach catalysts are complexes of transition metals such as Co, Mn and Fe.

The bleach system may additionally comprise a hydrophobic bleach compound. Examples are diacyl peroxides, (e.g. benzoyl peroxide), di-alkyl peroxides (e.g. di-tert-butyl peroxide), and peroxyesters (e.g. tert-butyl peroxy acetate).

In another aspect of the invention, the bleach is a hydrophilic bleach or precursors thereof. Preferably, the hydrophilic bleach is a perboric acid, percarbonic acid, hypochloric acid or a hypobromic acid; salts thereof; or precursors thereof. Hydrophilic bleaches and precursors thereof have been found to provide excellent cleaning performance in removing highly coloured soils, especially carotenoid soils, from plastic dishware. Carotenoid soils, such as α-, β-, γ-carotene and lycopene and xanthophylls (zeaxanthin or capsanthin), are derived from carrots and tomatoes and in any processed products containing these components, as well as certain tropical fruits and saffron.

Exothermically hydrating salts, such as for example K₂CO₃ or MgSO₄, may be used in combination with these hydrophilic bleaches, to generate heat when contacted with water, to increase the bleach activity.

The total amount of bleach in the composition applied to the substrate can range from 1 to 30%, preferably 3 to 20%, by weight of composition.

We find that the inclusion of bleach in the wipe provides the benefit of reduction of malodor. In particular, we find that inclusion of bleach reduces malodor from the wipe itself, which can otherwise arise after one or more uses.

In the present invention the bleach acts by formation of a peroxy anion. Thus it does not act by means of a free radical reaction (the composition applied to the substrate generally does not contain free radical initiators). The composition applied to the substrate is thus preferably such that in use it provides an alkaline aqueous environment, generally of pH from 8 to 12, preferably 8 to 10.

A further advantage, which we find is associated with the ability to include specific types of bleach in cleaning wipes is reduction of discoloration of the wipes during use. In particular, we find that wipes of the invention preferably show a change in whiteness (L, measured as discussed below) of not more than 25%, preferably not more than 20%, more preferably not more than 15% and in particular not more than 10% from whiteness before use, based on whiteness before use.

Cyclodextrin

In some embodiments we find that it is preferred to include a cyclodextrin in the composition. In particular we include cyclodextrin which encapsulates the peroxy carboxylic acid bleach or hydrophilic peroxy carboxylic acid bleach precursor. This can also provide the benefit of controlling release of bleach over time.

The preferred level of cyclodextrin, if used, is in the range of from 14 to 28 wt % based on total composition applied to the substrate. Preferred levels are from 40 to 80 wt %, based on total bleach in the composition.

Any of the known cyclodextrins can be used, for instance α-cyclodextrin, β-cyclodextrin and γ-cyclodextrin, with hydroxypropyl-beta-cyclodextrin and methyl-beta-cyclodextrin being preferred.

Diamines

An optional although preferred ingredient of the cleaning composition according to the present invention when used as a hand dishwashing wipe, is a diamine.

The cleaning composition will preferably contain at least about 0.1%, more preferably at least about 0.2%, even more preferably, at least about 0.25%, even more preferably still, at least about 0.5% by weight of said composition of diamine. The composition will also preferably contain no more than about 15%, more preferably no more than 10%, even more preferably, no more than about 6%, even more preferably, no more than about 5%, even more preferably still, no more than about 1.5% by weight of said composition of diamine.

It is preferred that the diamines used in the present invention are substantially free from impurities. That is, by “substantially free” it is meant that the diamines are over about 95% pure, i.e., preferably about 97%, more preferably about 99%, still more preferably 99.5%, free of impurities. Examples of impurities, which may be present in commercially supplied diamines, include 2-Methyl-1,3-diaminobutane and alkylhydropyrimidine.

Further, it is believed that the diamines should be free of oxidation reactants to avoid diamine degradation and ammonia formation.

Preferred organic diamines are those in which pK1 and pK2 are in the range of about 8.0 to about 11.5, preferably in the range of about 8.4 to about 11, even more preferably from about 8.6 to about 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from about C4 to about C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines.

As a working definition herein, the pKa of the diamines is specified in an all-aqueous solution at about 25° C. and for an ionic strength between about 0.1 to about 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, NY, 1990.

It has been determined that substituents and structural modifications that lower pK1 and pK2 to below about 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure: 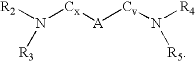
wherein R₂₋₅ are independently selected from H, methyl, —CH₃CH₂, and ethylene oxides; Cₓ and Cᵥ are independently selected from methylene groups or branched alkyl groups where x+y is from about 3 to about 6; and A is optionally present and is selected from electron donating or withdrawing moieties chosen to adjust the diamine pKa's to the desired range. If A is present, then x and y must both be about 1 or greater.

Examples of preferred diamines can be found in the co-pending provisional patent application of Phillip Kyle Vinson et al., entitled “Dishwashing Detergent Compositions Containing Organic Diamines for Improved Grease Cleaning, Sudsing, Low Temperature Stability and Dissolution”, having P & G Case No. 7167P, application Ser. No. 60/087,693, and filed on Jun. 2, 1998, which is hereby incorporated by reference.

Polymeric Suds Stabilizer

The cleaning composition of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:
i) homopolymers of (N,N-dialkylamino)alkyl acrylate esters having the formula: 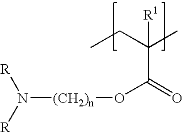
   wherein each R is independently hydrogen, C₁-C₈ alkyl, and mixtures thereof, R¹ is hydrogen, C₁-C₆ alkyl, and mixtures thereof, n is from about 2 to about 6; and
ii) copolymers of (i) and 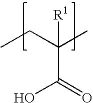
   wherein R¹ is hydrogen, C₁-C₆ alkyl, and mixtures thereof, provided that the ratio of (ii) to (i) is from about 2 to about 1 to about 1 to about 2; Another preferred polymeric suds stabilizer is a copolymer of (i) and hydroxy ethyl acrylate or hydroxy propyl acrylate.

The molecular weight of the polymeric suds boosters, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

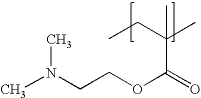

When present in the cleaning composition herein, the polymeric suds booster may be present in the composition from about 0.01% to about 15%, preferably from about 0.05% to about 10%, more preferably from about 0.1% to about 5%, by weight.

Other Optional Ingredients

The cleaning composition may comprise additional ingredients selected from the group consisting of thickening polymers, film-forming polymers, colorants, perfume and perfume delivery agents, stabilizers, solvents, density control agents, drying agents, hydrotropes, salt, solidification agents, preservation agents, water spotting/filming/drying control agents, and mixtures thereof.

Thickening polymers may be employed to impart increases in the yield value or shear viscosity at a given shear rate. They may also improve smear and extrusion properties due to their viscoelastic nature in concentrated surfactant products. They also may assist in achieving the desired processing properties for such requirements as during application of the surfactant system to the substrate (die extrusion). An example of a thickening polymer is polyacrylic acid, commercially available as Carbopol ETD2623® from Noveon.

Film forming polymers may be employed to inhibit surfactant release, water migration, or prevent undesired environmental influences on the stability of the one or more components of the surfactant present in the cleaning composition. An example of a film forming polymer is polyvinylpyrrolidone (PVP) commercially available as Molwiol brand® from Clariant.

Stabilizers may be employed to protect one or more components of the surfactant system. Stabilizers may include butylated hydroxytoluene (BHT), butylated hydroxyanisole (BHA), sodium benzoate for radical scavenging, benzophenone-4 for color stability, and silicates for undesired surfactant aging. Benzophenone-4 is commercially available as UVINUL® MS-40 from BASF.

Solvents may be employed to control the phase chemistry of the surfactant system. Solvents examples such as polyethylene glycol, polypropylene glycol, and polybutylene glycol available from Dow Chemical.

Density control agents may be employed to modify the density of the phase(s) to improve stability. An example of a suitable density control agent is air or sodium sulfate available from Saskatchewan Minerals.

Drying agents may be employed to improve the aging and final properties of the surfactant. An example of a drying agent to bind free water is magnesium sulfate available from Aldrich.

Hydrotropes may be employed to modify the phase chemistry to improve stability or modify dissolution properties of the surfactant. An example of a hydrotrope is sodium cumene sulfonate Naxonate SC® available from Rutgers Organics.

Salts may be employed to modify the phase chemistry to improve stability or modify dissolution properties of the surfactant. Preferably, the salt added is a magnesium and/or calcium salt in order to provide magnesium and/or calcium to the cleaning composition. An example of a salt is magnesium chloride available from Dow Chemical.

Solidification agents may be used to improve the solid properties and rheology of the final surfactant. An example of a few solidification agents are stearyl alcohol sulfates (Lanette E® available from Cognis), stearyl alcohols available from P&G Chemicals, fatty acids like stearic acid available from P&G Chemicals, PEG 4000-20000 available from Dow Chemical/Union Carbide, sodium sulfate available from Saskatchewan Minerals, and the like.

Preservation agents may be employed to prevent microbial growth in the surfactant. An example of a preservative is methylchloroisothiazolinone/methylisothiazolinone mixture (Kathon CG/ICP-II® available from Rohm & Haas).

Water spotting and filming control agents may be employed to improve the final rinsing and subsequent drying. An example of a water spotting/filming agent is a copolymer of acrylic acid and methacrylic acid (Acusol 445N® available from Rohm and Haas). An example of a water drying agent is a tallow alcohol ethoxylate (18 mole EO) available from Texaco.

In a highly preferred embodiment according to the present invention, the cleaning composition additionally comprises 1,3-bisaminomethyl cyclohexane, magnesium and/or calcium ions, and poly(dimethylaminoethyl methacrylate)acetate.

Methods of Manufacture

The wipes of the present invention are manufactured by adding the cleaning composition to the second layer herein via a conventional method which may include, but is not limited to, sprinkling, dip coating, spraying, slot coating, and roll transfer (e.g., pressure roll or kiss roll). The sheet of the remaining layer or layers, when present, is then placed on the sheet of the second layer, preferably, but not always, over the cleaning composition. The sheets are preferably sealed together by heat spot sealing. The abrasive coating may be applied onto the second layer by screen printing a thermoplastic material (preferably a hot melt adhesive). The sealed sheets are then partitioned into units for the consumer's use. Optional manufacturing steps may include calendaring to flatten the article, drying, creping, shrinking, stretching, or otherwise mechanically deforming.

Process of Cleaning Dishware and A Hard Surface

The present invention also encompasses a process of cleaning dishware, preferably to a process of cleaning dishware by hand.

This process comprises the steps of: a) wetting the wipe according to the present invention with water and b) contacting the dishware with the wetted wipe.

Additionally the process of cleaning dishware herein additionally comprises the step of mechanically agitating the wipe over said dishware (wiping) and/or rinsing said dishware with water.

In a preferred embodiment, the present invention also relates to a process of cleaning a hard surface, preferably a kitchen hard surface. The process of cleaning a hard surface comprises the steps of: a) wetting the wipe according to the present invention with water and b) contacting the hard surface with the wetted wipe. Additionally the process of cleaning a hard surface herein additionally comprises the step of mechanically agitating the wipe over said hard surface (wiping) and/or rinsing said hard surface with water.

The wipes of the present invention are water-activated and are therefore intended to be wetted with water prior to use. As used herein, “water-activated” means that the present invention is presented to the consumer in dry form to be used after wetting with water.

Accordingly, the article is wetted by immersion in water or by placing it under a stream of water.

### EXAMPLES

The following examples further describe and demonstrate embodiments within the scope of the present invention. In the following examples, all ingredients are listed at an active level. The examples are given solely for the purpose of illustration and are not to be construed as limitations of the present invention, as many variations thereof are possible without departing from the spirit and scope of the invention.

Prepare a representative disposable dish care and hard surface cleaning wipe article in the following manner:

The wipe comprises 5 layers of substrate. The first layer substrate is a spunlace blend of 40% viscose rayon and 60% polypropylene fibers, having a basis weight of about 60 gsm. The second layer is a low density polyethylene (LDPE) film of 19 gsm. The third and fourth layers are made from air-laid, lofty, low density nonwoven comprises a mixture of polyethylene terephthalate (PET) and PET-polyetheylene bicomponent fibers. The thickness of the batting is about 0.1 to 0.2 in. measured at 5 gsi (grams per square inch). The fifth layer of substrate is a clear polypropylene/EVA scrim mesh of 30 gsm. The cleaning compositions is applied to the surface of the batting layer which is in connection with the LDPE film. The cleaning composition is in the form of a paste and applied to the wipe substrate in stripes.

### Example A

Buffering of amphoteric surfactants and small organic compounds with the appropriate pKa—Amine Oxide (pKa=8) and 1,3 cyclohexane diamine (pKa=10) A premix paste is prepared using the composition below using a dual amine oxide diamine organic buffering system.

Premix paste composition

| | | % Wt. in |
|---|---|---|
| | Ingredient | control |
| Starting Product Material | Function | formula |
| Na AE0.6S | Cleaning | 48.00 |
| Amine Oxide | Cleaning/Buffering | 11.00 |
| Nonionic C11E9 | Cleaning | 5.50 |
| 1,3 Cyclohexane diamine | Cleaning/Buffering | 1.00 |
| Polymer (polyDMAM) | Sudsing | 0.40 |
| PSB, (27%) | | |
| Miscellaneous (water) | — | 34.100 |
| | | 100.00 |

Premix paste is passed through a thin film evaporator with a wall temperature of 130 C (paste temperature 120 C) for an approximate residence time of 10 minutes. The resulting composition is cooled to ambient temperature. Perfume and dye are added and the mixture homogenized in a turbulizer resulting in finished paste composition below

Finished paste composition:

| | | % Wt. in |
|---|---|---|
| | Ingredient | control |
| Finished Product Material | Function | formula |
| Na AE0.6S | Cleaning | 65.60 |
| Amine Oxide | Cleaning/Buffering | 14.90 |
| Nonionic C11E9 | Cleaning | 7.45 |
| 1,3 Cyclohexane diamine | Cleaning/Buffering | 1.40 |
| Polymer (polyDMAM) | Sudsing | 0.60 |
| PSB, (27%) | | |
| Perfume | Perfume | 2.00 |
| Sandolan Blue EHRL 180 | Colorant | 0.05 |
| Miscellaneous (water) | — | 8.000 |
| | | 100.00 |

### Example B

This Example Details the Use of an Inorganic Buffering System with Na2CO3 at pKa 10.5

A premix paste is prepared using the composition below using a sodium carbonate as buffer.

Premix paste composition

| | | % Wt. in |
|---|---|---|
| | Ingredient | control |
| Starting Product Material | Function | formula |
| Na AE0.6S | Cleaning | 58.80 |
| Nonionic C11E9 | Cleaning | 5.40 |
| Polymer (polyDMAM) | Sudsing | 0.40 |
| PSB, (27%) | | |
| Sodium Carbonate | Buffering | 1.90 |
| Miscellaneous (water) | — | 33.500 |
| | | 100.00 |

Premix paste is passed through a thin film evaporator with a wall temperature of 130 C (paste temperature 120 C) for an approximate residence time of 10 minutes. The resulting composition is cooled to ambient temperature. Perfume and dye are added and the mixture homogenized in a turbulizer resulting in finished paste composition below

Finished paste composition:

| | | % Wt. in |
|---|---|---|
| | Ingredient | control |
| Finished Product Material | Function | formula |
| Na AE0.6S | Cleaning | 79.56 |
| Nonionic C11E9 | Cleaning | 7.26 |
| Sodium Carbonate | Buffering | 2.60 |
| Polymer (polyDMAM) | Sudsing | 0.53 |
| PSB, (27%) | | |
| Perfume | Perfume | 2.00 |
| Sandolan Blue EHRL 180 | Colorant | 0.05 |
| Miscellaneous (water) | — | 8.000 |
| | | 100.00 |

1. A wipe comprising a water-insoluble substrate and a cleaning composition, said cleaning composition comprising from 1% to 15% water, a sulphate-containing surfactant and a buffer.

2. A wipe according to the preceding claim wherein the cleaning composition comprises 2-12% water.

3. A wipe according to claim 1 wherein the sulphate-containing surfactant is selected from the group consisting of alkyl sulphate, alkyl alkoxy sulphate, alkyl ether sulphate and mixtures thereof.

4. A wipe according claim 1 wherein the sulphate-containing surfactant is present in an amount of 30% to 80% by weight of the cleaning composition.

5. A wipe according to claim 1 wherein the buffer is either organic or inorganic.

6. A wipe according to claim 1 wherein the buffer has a pKa of from 6 to 12.

7. A wipe according to claim 1 wherein the buffer comprises at least one selected from a basic group, a basic group in combination with an acidic group or a basic group in combination with a neutral group.

8. A wipe according to claim 1 wherein the wipe is dry or substantially dry to the touch.

9. A wipe according to claim 1 wherein the water-insoluble substrate comprises at least two outward facing surfaces, one of which is more abrasive than the other.

10. A wipe according to claim 1 wherein the water-insoluble substrate is a laminate of more than two substrate layers.

11. A wipe according to claim 1 wherein the water-insoluble substrate comprises a water impermeable film.

12. A wipe according to claim 1 wherein the cleaning composition is in the form of a paste.

13. A wipe according to claim 1 wherein the cleaning composition is coloured with a dye or pigment.

14. A wipe according to claim 1 wherein the cleaning composition is applied onto the wipe as strips of paste and wherein the strips may be the same or different colours.

15. A wipe comprising a water-insoluble substrate, a first and a second cleaning composition, the first composition being formulated according to claim 1, the second composition comprising from 15% to 25% water.

16. A method of using a wipe according to claim 1 or claim 15 wherein the wipe is contacted with water before being applied to a surface to be cleaned.

17. A process of drying a sulphate-containing surfactant comprising heating the surfactant in a thin film evaporator to a temperature of 70 to 200° C. in the presence of a buffer, for a residence time of 10 minutes.
